(19) United States
(12) Patent Application Publication
(10) Pub. No.: US 2022/0181745 A1
(43) Pub. Date: Jun. 9, 2022

(54) POLYAMIDE-IMIDE COATED SEPARATORS FOR HIGH ENERGY RECHARGEABLE LITHIUM BATTERIES

(71) Applicant: Ceigard, LLC, Charlotte, NC (US)

(72) Inventors: Zhengming Zhang, Rock Hill, SC (US); Changqing Wang Adams, Fort Mill, SC (US); Stefan Reinartz, Waxhaw, NC (US)

(21) Appl. No.: 17/601,088

(22) PCT Filed: Apr. 2, 2020
(86) PCT No.: PCT/US2020/026355

§ 371 Date: Oct. 4, 2021

Related U.S. Application Data
(60) Provisional application No. 62/829,308, filed on Apr. 4, 2019.

(51) Int. Cl. H01M 50/449; H01M 50/423; H01M 10/0525

(52) U.S. Cl. CPC H01M 50/449; H01M 10/0525; H01M 50/423

(57) ABSTRACT

The instant disclosure or invention is preferably directed to a polyamide-imide coated membrane, separator membrane, or separator for a lithium battery such as a high energy or high voltage rechargeable lithium battery and the corresponding battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function). Although secondary lithium battery usage may be preferred, the instant polyamide-imide coated membrane may be used in a battery, cell, primary battery, capacitor, fuel cell, textile, filter, and/or composite, and/or as a layer or component in other applications, devices, and/or the like.

### CROSS-REFERENCE TO RELATED APPLICATIONS

This application is a 371 application of PCT Application No. PCT/US2020/026355, Filed Apr. 2, 2020, which claims priority to U.S. Provisional Patent Application Ser. No. 62/829,308 filed Apr. 4, 2019, both hereby incorporated by reference herein.

### FIELD OF THE INVENTION

The instant disclosure or invention is preferably directed to a polyamide-imide coated membrane, separator membrane, or separator for a lithium battery such as a high energy or high voltage rechargeable lithium battery and the corresponding battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function). Although secondary lithium battery usage may be preferred, the instant polyamide-imide coated membrane may be used in a battery, cell, primary battery, capacitor, fuel cell, textile, filter, and/or composite, and/or as a layer or component in other applications, devices, and/or the like.

In at least selected embodiments, objects or aspects, the instant disclosure or invention is directed to a polyamide-imide coated membrane, separator membrane, or separator for a secondary lithium battery such as a high energy or high voltage rechargeable lithium ion battery, polymer battery, or metal battery and the corresponding battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function).

In at least some embodiments, objects, or aspects, the instant disclosure or invention is directed to a polyamide-imide battery separator. The polyamide-imide battery separator may comprise, consist of, or consist essentially of a non-porous, semi-porous, microporous, mesoporous, macroporous, or nanoporous polyamide-imide layer or film. In some preferred embodiments, the polyamide-imide battery separator may comprise, consist of, or consist essentially of a polyamide-imide layer or film that is both porous and ionically conductive. For example, the layer or film may conduct lithium ions. In other preferred embodiments, the polyamide-imide battery separator may comprise, consist of, or consist essentially of a polyamide-imide layer or film that is nonporous or only semi-porous, but is also ionically conductive. For example, the layer or film may conduct lithium ions.

A separator for a high energy or high voltage rechargeable lithium battery and a high energy or high voltage rechargeable lithium battery are disclosed herein. In accordance with at least certain embodiments, objects or aspects, the instant disclosure or invention is directed to a polyimide coated separator for a high energy or high voltage rechargeable lithium battery and the corresponding battery. The separator preferably includes a porous, nonporous, or semi-porous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional stability, to reduce shrinkage, to add high temperature performance (HTMI function), to prevent electronic shorting at temperatures above 200 deg C., and/or the like. The microporous polymeric layer may be adapted, at least, to hold liquid electrolyte, to conduct ions, and/or to block ionic flow between the anode and the cathode in the event of thermal runaway (shutdown function).

The polyamide-imide of the polyamide-imide coating or layer may be selected from the group consisting of a neat polyamide-imide, a 30% glass fiber polyamide-imide, a 30% carbon fiber polyamide-imide, a polyamide-imide comprising carbon fiber, a polyamide-imide comprising graphite, and combinations of the foregoing.

In some embodiments, the battery separator consists of or consists essentially of a polyamide-imide layer or film. The polyamide-imide layer or film in such embodiments is not a coating on a microporous polymeric base layer. The polyamide-imide layer is freestanding.

### BACKGROUND OF THE INVENTION

A high energy rechargeable lithium battery may have an anode with an energy capacity of at least 372 milliampere-hours/gram (mAh/g). Such anodes may include, for example, lithium metal, lithium alloys (e.g. lithium aluminum), and mixtures of lithium metal or lithium alloys and materials such as carbon, nickel, and copper.

A high voltage rechargeable lithium battery may have a voltage of at least 4.5 V, 4.7 V, or more. Such batteries may have anodes with lithium intercalation or lithium insertion compounds.

The commercial success of certain high energy and high voltage secondary or rechargeable lithium ion batteries has been hampered by persistent cycling or safety issues or problems.

One common solution is a ceramic coated separator (CCS) as described, for example, in U.S. Pat. No. 6,432,586 hereby fully incorporated by reference herein. The difficulties associated with the use of certain CCS in selected batteries or cells may include that the ceramic particles can flake off during cell manufacture, the ceramic coating is abrasive, hard to slit, and can wear out equipment and slitter blades, the ceramic coating adds thickness, cost and complexity, and the like.

Some have proposed the use of gel electrolytes or polymer electrolytes in place of the CCS. These gel electrolytes or polymer electrolytes may not have sufficient dimensional stability (do not hold their shape) and may not have good ion conductivity. Liquid electrolyte may have 10× the conductivity of a gel electrolyte or polymer electrolyte.

Also, gel electrolytes or polymer electrolytes may not prevent dendritic shorts. Lithium dendrite growth can occur after repetitive charge-discharge cycling. While dendrite growth is a potential problem with any lithium battery, the severity of the problem is increased by use of high energy anodes (e.g. metal, metal alloy, or pure carbon intercalation anodes). When lithium dendrites grow and penetrate the separator, an internal short circuit of the battery occurs (any direct contact between anode and cathode is referred to as “electronic” shorting, and contact made by dendrites is a type of electronic shorting). Some shorting (i.e., a soft short), caused by very small dendrites, may only reduce the cycling efficiency of the battery. Other shorting, such as a hard short, may result in thermal runaway of the lithium battery, a serious safety problem for lithium rechargeable batteries.

Accordingly, there is a need to improve separators for at least high energy or high voltage rechargeable lithium batteries.

### SUMMARY OF THE INVENTION

In accordance with at least selected embodiments of the invention or disclosure, new or improved inventive separators may address the above needs, issues or problems, and/or may provide polyamide-imide coated membranes, separators or separator membranes adapted for use in a battery, cell, primary battery, secondary battery, high energy or high voltage rechargeable lithium battery, capacitor, fuel cell, textile, filter, and/or composite, and/or as a layer or component in other applications, devices, and/or the like. In accordance with at least some selected embodiments of the invention or disclosure, new or improved inventive separators may address the above needs, issues or problems, and/or may provide polyamide-imide membranes, films, layers, separators or separator membranes adapted for use in a battery, cell, primary battery, secondary battery, high energy or high voltage rechargeable lithium battery, capacitor, fuel cell, textile, filter, and/or composite, and/or as a layer or component in other applications, devices, and/or the like.

The instant disclosure or invention is preferably directed to a polyamide-imide coated membrane, separator membrane, or separator for a lithium battery such as a high energy or high voltage rechargeable lithium battery and the corresponding battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function). Although secondary lithium battery usage may be preferred, the instant polyamide-imide coated membrane may be used in a battery, cell, primary battery, capacitor, fuel cell, textile, filter, and/or composite, and/or as a layer or component in other applications, devices, and/or the like.

In at least selected embodiments, objects or aspects, the instant disclosure or invention is directed to a polyamide-imide coated membrane, separator membrane, or separator for a secondary lithium battery such as a high energy or high voltage rechargeable lithium ion battery, polymer battery, or metal battery and the corresponding battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function).

The polyamide-imide of the polyimide coating or layer may be neat polyamide-imide, a 30% glass fiber polyamide-imide, a 30% carbon fiber polyamide-amide, a polyamide-imide comprising carbon fiber, a polyamide-imide comprising graphite, and combinations thereof. As understood by those skilled in the art, a “neat” polymer “neat” means that the polymer is a essentially a pure compound and consists only of the molecules of the polymer produced.

A separator for a high energy or high voltage rechargeable lithium battery and a high energy or high voltage rechargeable lithium battery are disclosed herein. In accordance with at least certain embodiments, objects or aspects, the instant disclosure or invention is directed to a polyamide-imide coated separator for a high energy or high voltage rechargeable lithium battery and the corresponding battery. The separator preferably includes a porous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional stability, to reduce shrinkage, to add high temperature performance (HTMI function), to prevent electronic shorting at temperatures above 200 deg. C., and/or the like. The microporous polymeric layer may be adapted, at least, to hold liquid electrolyte, to conduct ions, and/or to block ionic flow between the anode and the cathode in the event of thermal runaway (shutdown function).

In accordance with at least certain embodiments, the instant disclosure or invention is directed to a novel or improved separator for a high energy or high voltage rechargeable lithium battery and the corresponding battery. The inventive separator includes at least one polyamide-imide layer, treatment, material, deposition, or coating and at least one polymeric porous or microporous base layer. The polyamide-imide coated separator is adapted, at least, to block dendrite growth and to prevent electronic shorting. The polymeric base layer is adapted, at least, to block ionic flow between the anode and the cathode in the event of thermal runaway.

General chemical structure of a polyamide-imide is shown in the following chemical formula 1:

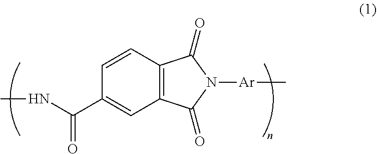

In this formula, Ar is an aryl group and n is an integer of 2 or more. An aryl group is under to be a functional group or substituent comprising, consisting of, or consisting essentially of an aromatic ring. For example, the aryl may be at least one selected from the group consisting of phenyl, tolyl, xylyl, naphthyl, a phenyl ether, or others. Polyamide-imide (sometimes abbreviated PAI) is generally prepared from isocyanates and TMA (trimellic acid anhydride) in N-methyl-2-pyrrolidone (NMP). Polyamide-imides have high heat resistance. One example of a commercially available PAI is Torlon®, which is made by the company Solvay Specialty Polymers. Another example is VYLOMAX® available from Toyobo. Another example is Duratron® by Quadrant Plastics. Other companies that manufacture PAI include Innotek Technology Ltd., Axalta Coating Systems, LLC, Toyobo Co., Ltd, Nuplex Resins, LLC, Fujifilm, Hitachi Resins, LLC, Drake Plastics Ltd Co., Mitsubishi Shoji, Solvay S A, Kermel, Elantas, Shanghai Songhan Plastics Technology Co. Ltd, and Ensinger GmbH Polyamide-imides are either thermosetting or thermoplastic, amorphous polymers that have exceptional mechanical, thermal, and chemical resistance properties. PAIs display a combination of properties from both polyamides and polyimides, such as high strength, melt processability, exceptional high heat capability, and broad chemical resistance.

In accordance with one or more possibly preferred processes, an HTMI polymer and an ionically conductive polymer are mixed with a solvent to form a coating solution, which may be used to form the HTMI polymer coating, film, or layers described herein. In another possibly preferred embodiment, an HTMI polymer, an ionically conductive polymer, and a ceramic are mixed with a solvent to form a coating slurry, which may be used to form the HTMI-polymer coating, film, or layers described herein. The HTMI polymer may in some embodiments be a polyamide-imide, but it is not limited to a polyamide-imide. The ionically conductive polymer, in some embodiments, may be in the form of particles or beads. The ionically conductive polymer may be a PVDF such as a PVDF-HFP where the amount of HFP is between 1 and 35%. The ionically conductive polymer, however, is not so limited. The ceramic may be, in some embodiments, silica, alumina, or combinations thereof. The ceramic, however, is not so limited. Any ceramic that is compatible with the battery in which the separator will be used may be used. For example, alumina may be used. Additionally, if the ceramic is going to be removed from the coating, a ceramic that would be incompatible with the battery in which the separator will be used may be used. For example, silica may be used and removed from the layer, film, or coating. For example, it may be removed using HF. In some embodiments, the solvent may be NMP, but it is not so limited. Any solvent that can dissolve the HTMI polymer and the ionically conductive polymer may be used. For example, a solvent that can dissolve polyamide-imide and a PVDF or PVDF-HFP may be used. Known solvents for polyamide-imide include dipolar aprotic solvents such as NMP, DMAC, DMF, and DMSO to at least 35% solids.

The coating solution or slurry may be coated onto a base film that is porous or microporous or onto any other suitable substrate such as a glass plate. When forming a free-standing HTMI-polymer coating, film, or layer, the coating solution or slurry may be formed on a glass plate or other substrate from which the final film, coating or layer may be removed. The porous or microporous base film may be a dry-process porous or microporous base film, including any microporous film sold by Celgard®. Although dry process base films such as polyolefin dry process base films may be preferred, especially such films made from polypropylene, wet process, particle stretch, beta nucleated biaxially oriented polypropylene (BNBOPP), and other microporous membranes or films may be used.

Once the coating slurry or coating solution is coated to form a film, coating, or layer, the solvent may be removed or substantially removed. The solvent may be removed or substantially removed by heating in an oven or by immersing the film, coating, or layer in an aqueous solution and then drying the film, coating, or layer. The aqueous solution may be more than 50% water by volume. In some preferred embodiments, the aqueous solution is 100% water or just water. Immersion time may be from about 1 minute to about an hour, from about 1 minute to about 50 minutes, from about 1 minute to about 40 minutes, from about 1 minute to about 30 minutes, from about 1 minute to about 20 minutes, from about 1 minute to about 10 minutes, or from about 1 minute to about 5 minutes. About 5 minutes means 0, 1, 2, 3, 4, 5, 6, 7, 8, 9, or 10 minutes or 5 minutes ±5 minutes. Drying may be achieved by oven drying or air drying.

In some embodiments, removal or substantial removal of the solvent using an aqueous solution may also result in the removal of polymer. For example, the HTMI polymer, the ionically conductive polymer, or both may be removed. This may result in formation of pores or voids in the film, layer, or coating. Without wishing to be bound by any particular theory, it is believed that immersion of the film, layer, or coating described herein into an aqueous solution or 100% water, results in a phase inversion process that removes solvent and some polymer from the film, layer, or coating. It is believed that the extent of polymer removal depends on factors, and particularly on immersion time. Longer immersion times are believed to result in more polymer being removed.

In embodiments where a coating slurry comprising a ceramic is used, the ceramic may be removed or may not be removed from the coating, film, or layer. If the ceramic is incompatible with the battery that the separator is intended to be used in, the ceramic should be removed. For example, silica may be incompatible with a Li-ion battery, and should be removed if the separator is to be used in such a battery. For example, silica may be removed using HF. If the ceramic is compatible with the battery in which the separator is intended to be used, the ceramic does not need to be removed. For example, if the separator is intended to be used in a Li-ion battery, then alumina may be used and does not need to be removed from the coating, film, or layer. Without wishing to be bound by any theory, it is believed that the addition of a ceramic may decrease the Gurley and the ER of the film, coating, or layer. The amount of ceramic in the coating slurry may be from 1 to 50%, from 1 to 40%, from 1 to 30%, from 1 to 40%, from 1 to 20%, from 1 to 10%, or from 1 to 5% based on the total solids. The final coating, film, or layer, may have different amounts of ceramic, depending on whether the ceramic is removed, partially removed, or not removed.

### DESCRIPTION OF THE DRAWINGS

For the purpose of illustrating the invention, there is shown in the drawings a form which is presently preferred; it being understood, however, that this invention is not limited to the precise arrangements and instrumentalities shown.

### DESCRIPTION OF THE DRAWINGS

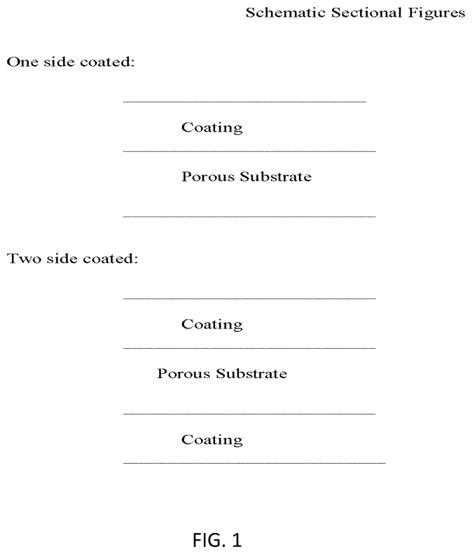

FIG. 1 shows a schematic of a one-side and two-side coated inventive separator where one or two sides of a porous substrate are coated with a polyamide-imide or HTMI coating.

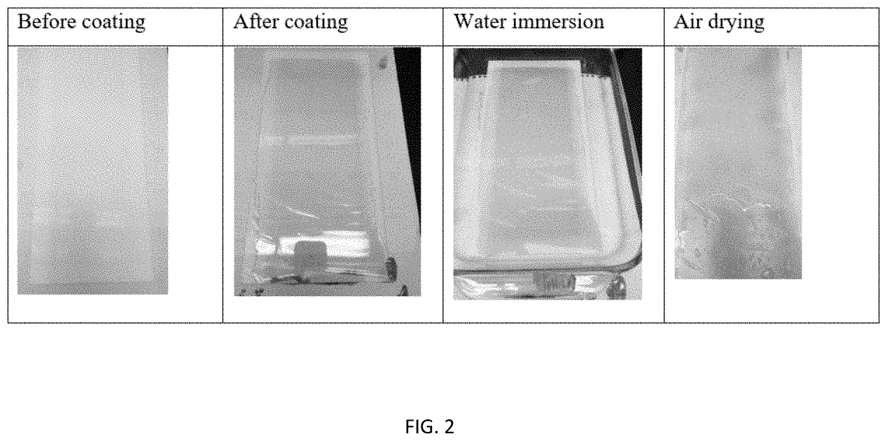

FIG. 2 is a photograph of a wet coating, film, or layer according to some embodiments described herein.

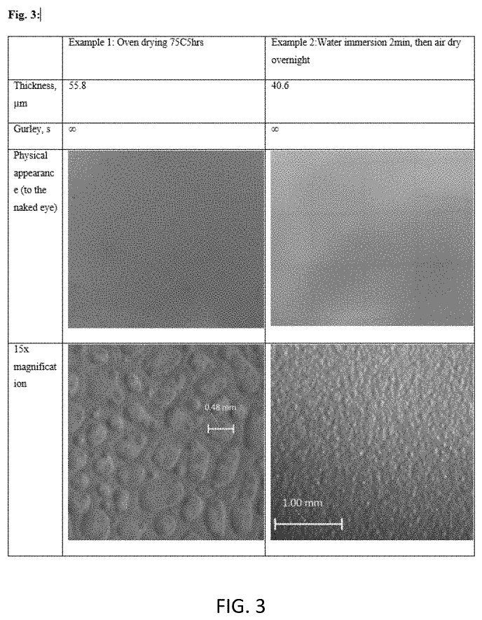

FIG. 3 is a Table showing certain results for Examples 1 and 2 described herein.

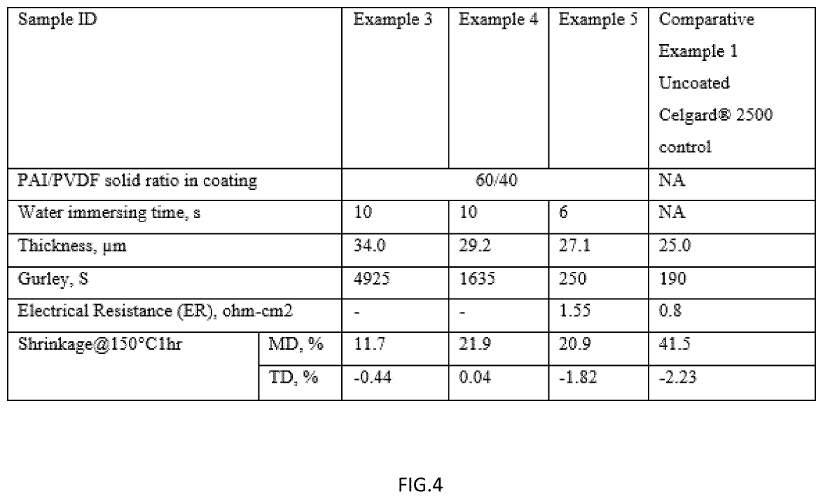

FIG. 4 is a Table showing certain properties and results for inventive and comparative embodiments described herein.

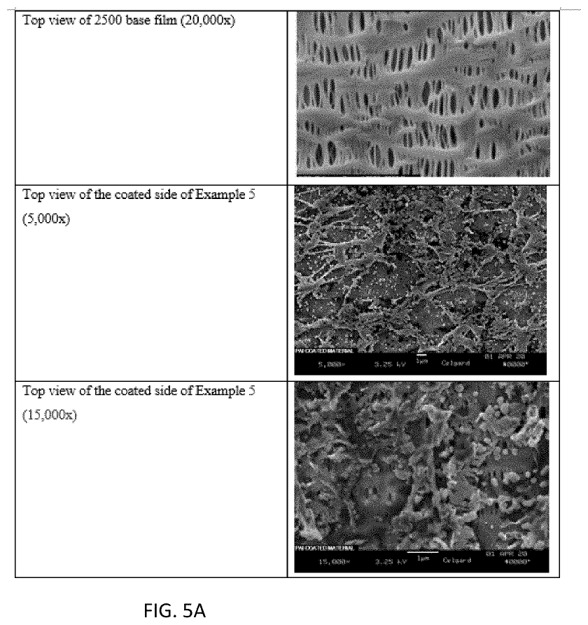

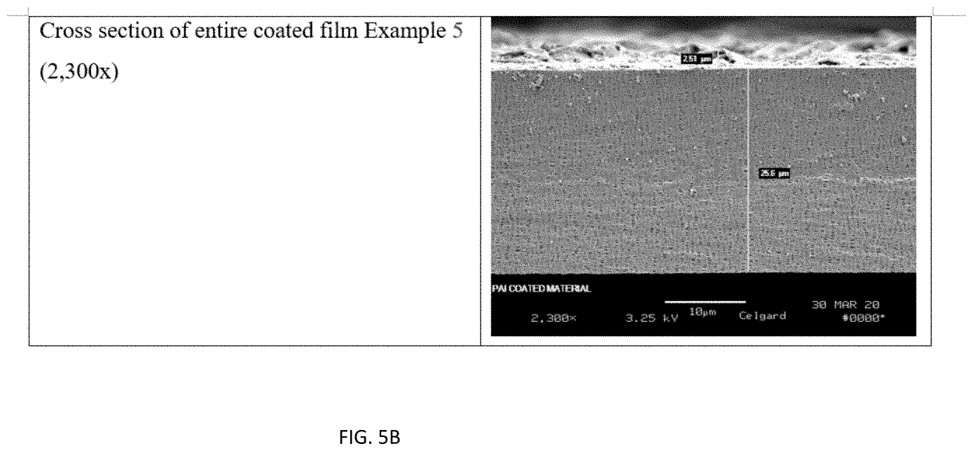

FIGS. 5A and 5B include a Table with SEMs of certain embodiments described herein.

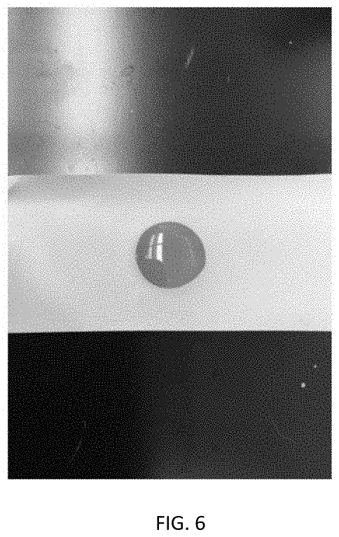

FIG. 6 is a photograph showing that certain embodiments herein wet with electrolyte.

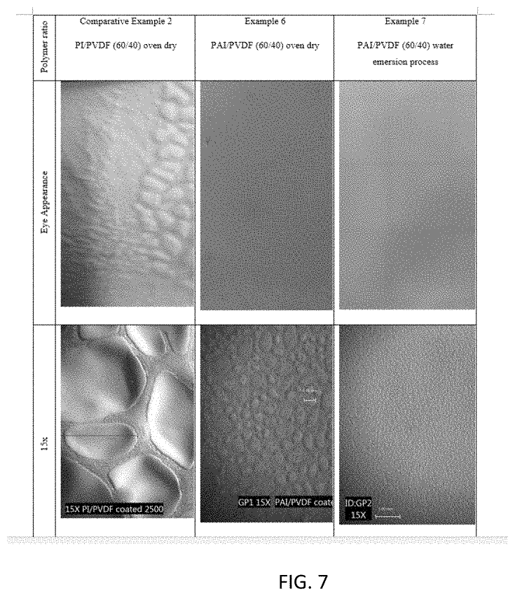

FIG. 7 is a Table including certain properties and SEMs for embodiments described herein.

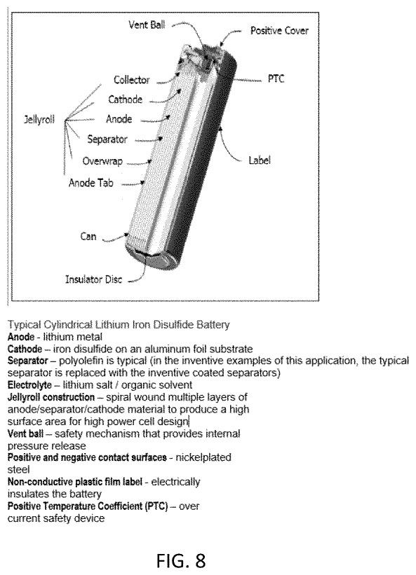

FIG. 8 is a cutaway view of the interior of an example battery in accordance with one embodiment herein.

### DETAILED DESCRIPTION

A typical lithium battery (or cell) comprises a lithium metal or alloy anode, a cathode, and a separator disposed between the anode and cathode, all of which is packaged within a can or pouch of a cylindrical cell or ‘jelly roll’ cell, or a prismatic or stacked cell. The invention is not limited to a particular battery or cell configuration, and may also be well suited for button cells, polymer cells, and the like. Additionally, the electrolyte may be a liquid (organic or inorganic), or a gel (or polymer). The invention will be, for convenience, described with regard to a cylindrical cell with a liquid organic electrolyte, but it is not so limited and may find use in other cell types (e.g. energy storage system, capacitor, combined cell and capacitor) and configurations.

The possibly preferred anode should have a high energy or high voltage capability or capacity, preferably greater than or equal to 372 mAh/g, preferably 700 mAh/g, and most preferably 1000 mAH/g. The preferred anode may be constructed from a lithium metal foil or a lithium alloy foil (e.g. lithium aluminum alloys), or a mixture of a lithium metal and/or lithium alloy and materials such as carbon (e.g. coke, graphite), nickel, copper. The anode may include intercalation compounds containing lithium or insertion compounds containing lithium.

The cathode may be any cathode compatible with the anode and may include an intercalation compound, an insertion compound, or an electrochemically active polymer. Suitable intercalation materials includes, for example, MoS2, FeS2, MnO2, TiS2, NbSe3, LiCoO2, LiNiO2, LiMn2O4, V6O13, V2O5, and CuCl2. Suitable cathode polymers include, for example, polyacetylene, polypyrrole, polyaniline, and polythiopene.

The electrolyte may be liquid or gel (or polymer). Typically, the electrolyte primarily consists of a salt and a medium (e.g. in a liquid electrolyte, the medium may be referred to as a solvent; in a gel electrolyte, the medium may be a polymer matrix). The salt may be a lithium salt. The lithium salt may include, for example, LiPF6, LiAsF6, LiCF3 SO3, LiN(CF3 SO3)3, LiBF6, and LiClO4, BETTE electrolyte (commercially available from 3M Corp. of Minneapolis, Minn.) and combinations thereof. Solvents may include, for example, ethylene carbonate (EC), propylene carbonate (PC), EC/PC, 2-MeTHF(2-methyltetrahydrofuran)/EC/PC, EC/DMC (dimethyl carbonate), EC/DME (dimethyl ethane), EC/DEC (diethyl carbonate), EC/EMC (ethylmethyl carbonate), EC/EMC/DMC/DEC, EC/EMC/DMC/DEC/PE, PC/DME, and DME/PC. Electrolyte polymer matrices may include, for example, PVDF (polyvinylidene fluoride), PVDF:THF (PVDF:tetrahydrofuran), PVDF:CTFE (PVDF: chlorotrifluoro ethylene), PVDF-HFP, PAN (polyacrylonitrile), and PEO (polyethylene oxide).

Referring to FIGS. 1 and 2, exemplary separators include at least HTMI-polymer-containing coating or layer on at least one side of a porous layer, base-film, or membrane. In some embodiments the HTMI-polymer-containing coating or layer is a polyamide-imide coating or layer. In the battery, the HTMI-polymer-containing coating or layer or the polyamide-imide coating or layer during normal battery or cell operating conditions must be sufficiently ionically conductive to allow ionic flow between the anode and cathode, so that current, in desired quantities, may be generated by the cell. In some embodiments, this may be achieved by including an ionically conductive additive, such as an ionically conductive polymer, to the coating or layer containing the HTMI polymer or a polyamide-imide. In some embodiments, this may be achieved by including a ceramic in the coating, and optionally removing the ceramic to generate voids, pores, or holes. The coating and base film should adhere well to one another. The coating and base film layers may be formed by lamination, coextrusion, deposition, or coating processes. The HTMI-polymer-containing or polyamide-imide-containing coating may be a coating, a discrete layer, or a free-standing layer either having a thickness ranging from 0.001 micron to 50 microns, preferably in the range of 0.01 micron to 15 microns or less. The polymeric microporous layer is preferably a discrete membrane having a thickness ranging from 5 microns to 50 microns, preferably in the range of 4 microns to 12 microns or more. The overall thickness of separator is in the range of 5 microns to 100 microns, preferably in the range of 6 microns to 25 microns.

The HTMI or polyamide-imide coating may be porous, microporous, semi-porous, or nonporous (it being understood that it is preferably porous, but that a nonporous coating layer may be ionically conductive when wet or wet out with an electrolyte dependent upon the materials making up the coating layer). For example, if the coating layer also includes an ionically conductive material such as an ionically conductive polymer, the coating layer may be ionically conductive.

In some embodiments, the HTMI-polymer-containing coating is a free-standing film or layer. It is not provided on a porous polymeric base film to form a separator, but instead is itself a separator.

### HTMI-Polymer-Containing Film, Layer, or Coating

The film, layer, or coating described herein may comprise, consist of, or consist essentially of a High Temperature Melt Integrity (HTMI) polymer. The HTMI polymer is not so limited, and may be any polymer having a melting point greater than 200° C. In a preferred embodiment, the HTMI polymer is a polyamide-imide. In some embodiments, it may be a polyetherimide.

The polyamide-imide disclosed herein is not so limited, and any polyamide-imide may be used that is not inconsistent with the stated goals herein. In some preferred embodiments, the polyamide-imide may be a neat polyamide-imide. In some embodiments, the polyamide-imide may be at least one selected from the group consisting of a neat polyamide-imide, a 30% glass fiber polyamide-imide, a 30% carbon fiber polyamide-amide, a polyamide-imide comprising carbon fiber, a polyamide-imide comprising graphite, and combinations thereof.

In addition to the HTMI polymer, the film, layer, or coating described herein may also contain one or more additional components. For example, the film, layer or coating may comprise, consist of, or consist essentially of an HTMI polymer and an ionically conductive additive. An ionically conductive additive may, in some embodiments, enable lithium ion transport across the separator when the separators disclosed herein are used in a lithium ion battery. For example, the ionically conductive additive may be a polymer that becomes ionically conductive when wet with electrolyte. In some embodiments, the ionically conductive may be PVDF or PVDF-HFP. The PVDF is not so limited, but in some preferred embodiments, the PVDF or PVDF-HFP is one that is soluble in the solvent N-methyl-2-pyrrolidone (NMP) or another solvent that polyamide-imide is also soluble in. Herein, soluble means, at least, that the polyamide-imide, PVDF, or PVDF-HFP does not precipitate out of solution when NMP is used as a solvent for the solution. In some preferred embodiments, the PVDF or PVDF-HFP is micron-sized, and in some preferred embodiments the PVDF or PVDF-HFP is micron-sized particles or beads. In some preferred embodiments, PVDF-HFP is used. The HFP content is not so limited, but in preferred embodiments may be less than 50%, less than 45%, less than 40%, less than 35%, less than 30%, less than 25%, less than 20%, less than 15%, or less than 10%. In some preferred embodiments, the HFP content may be from 5% to 30%, preferably from 5% to 25%.

In some preferred embodiments, the film, coating, or layer described herein comprises, consists of, or consists essentially of a polyamide-imide and at least one selected from the group consisting of a PVDF, PVDF-HFP, or combinations thereof. Some residual solvent may also be present in the final coating, film, or layer.

In some preferred embodiments, the coating, film, or layer may comprise, consist of, or consist essentially of an HTMI-polymer such as a polyamide-imide, an ionically conductive polymer such as PVDF, PVDF-HFP, or combinations thereof, and a ceramic such as alumina. Some residual solvent may also be present in the final coating, film, or layer.

In some preferred embodiments, the film coating or layer described herein is made by a method comprising a step of preparing a coating slurry or a coating solution. A coating solution may comprise, consist of, or consist essentially of an HTMI polymer, an ionically conductive polymer, and a solvent. A coating slurry may comprise, consist of, or consist essentially of an HTMI polymer, an ionically conductive polymer, a ceramic, and a solvent. In some preferred embodiments, the HTMI polymer is a polyamide-imide and the ionically conductive additive is at least one selected from the group consisting of a PVDF, PVDF-HFP, and combinations thereof, and the solvent is NMP. In some preferred embodiments, the ceramic is alumina, silica, or alkaline metal salts (KCl, LiCl, etc.). In some embodiments, a solution containing the HTMI polymer and a solution containing the ionically conductive additive may be prepared separately and mixed together to form the coating solution. In other embodiments, a single solution containing the HTMI polymer, the ionically conductive additive, and the solvent may be prepared and used as the coating solution. In some embodiments, a solution containing the HTMI polymer and the solvent and a solution containing the ionically conductive polymer may be separately formed. The ceramic may be added to either of these solutions before or after they are mixed together to form the coating slurry.

In some embodiment, a further step of applying the coating slurry or coating solution to a porous polymeric base film or to a substrate or support to form a coating, film, or layer is included in the method. In embodiments where the coating slurry or coating solution is applied to a porous polymeric base film, the coating slurry or coating solution may be applied to one or both sides thereof. In some embodiments, the coating slurry or coating solution may be applied to a substrate or support such as a glass substrate or support to form a coating on the substrate or support. In embodiments where the coating slurry or coating solution is applied to one or both sides of a porous polymeric base film, the coated base film may be used as a battery separator. In embodiments where the coating slurry or coating solution is applied to a substrate or support such as a glass substrate, the coating itself may be used as a battery separator.

In some embodiments, a further step of removing some, all, or substantially all of the solvent from the coating, film, or layer is included in the method described herein. In preferred embodiments, all or substantially all of the solvent may be removed from the coating applied to the porous polymeric base film or the substrate or support such as a glass substrate or support. For example, 80% or more, 85% or more, 90% or more, 95% or more, 96% or more, 97% or more, 98% or more, 99% or more, or 100% of the solvent is removed. In some embodiments, the solvent may be removed by heating the coating for a period of time. For example, in some embodiments, the coating may be heated at 50° C. or more, 55° C. or more, 60° C. or more, 65° C. or more, 70° C. or more, 75° C. or more, 80° C. or more, 90° C. or more, or 100° C. or more. Heating time may be from 1 to 20 hours, from 1 to 15 hours, from 1 to 10 hours, or from 1 to 5 hours. In some preferred embodiments, faster removal of NMP is achieved by heating the coating, film, or layer to higher temperatures. However, acceptable temperatures may be influenced by the makeup of the polymeric base film. Temperatures that will not melt or otherwise deform or destroy this base film should be used. In other embodiments, the solvent may be removed or substantially removed using a process having at least the following two steps: 1) water chasing and 2) air drying overnight at room temperature within plus or minus 5 degrees Celsius or oven drying Water chasing, in some preferred embodiments, may include immersing the coating, film, or layer in a dip tank containing water or an aqueous solution having more than 50% water or spraying the coating, film, or layer with water or an aqueous solution having more than 50% water to remove the solvent. The aqueous solution may have more than 50% water and another solvent such as an alcohol or any other solvent. In embodiments where NMP is used as the solvent, PAI is used as the HTMI polymer, and PVDF-HFP is used as the ionically conductive additive, NMP goes into the water leaving the PAI and PVDF-HFP behind. However, the NMP that goes into the water may, in some embodiments, carry polymer (either the HTMI polymer, the ionically conductive polymer, or both) with it. This may leave voids in the resulting film, layer, or coating. Immersion times (or the time that the water or aqueous solution remains in contact with the coating, film, or layer) may vary from 1 minute to 1 hour. Without wishing to be bound by any particular theory, it is believed that longer immersion times may result in more polymer being removed. In preferred embodiments, the water chasing method is used, the solvent is recovered/recycled for reuse.

In some embodiments where a coating slurry that contains ceramic is used, the ceramic may be removed from the coating, film, or layer. In some embodiments, the ceramic does not need to be removed. In embodiments where the ceramic should be removed, i.e., when the ceramic is incompatible with the final battery that the separator is intended to be used in, the ceramic may be removed. For example, a ceramic that is generally incompatible with Li-ion batteries is silica. If silica is used in a coating slurry, it can and should be removed or substantially removed if the separator is to be used in a Li-ion battery. One way of removing silica is by using HF.

In embodiments where the coating solution or coating slurry is provided directly on, for example, a glass substrate and the solvent is removed or substantially removed, the resulting coating may be removed from the glass substrate and the coating itself is free-standing and may be used as a battery separator. In such embodiments, any substrate that the resulting coating can be easily removed from is a good choice to use.

In some embodiments, the coated polymeric porous base (i.e., the separator) resulting after the solvent is removed or substantially removed has an infinite Gurley and is ionically conductive. In some embodiments, the separator may have a Gurley (s/100 cc) of 7,000 or less, 6,000 or less, 5,000 or less, 4,000 or less, 3,000 or less, 2,000 or less, 1,000 or less, or 500 or less. Without wishing to be bound by any particular theory, it is believed that using a ceramic in the coating, film, or layer may result in a separator with a lower Gurley. In some embodiments, a coated polymeric porous base (i.e., the separator) resulting after the solvent is removed or substantially removed may have an electrical resistance (ER) less than 50, less than 45, less than 40, less than 35, less than 30, less than 25, less than 20, less than 15, less than 10, less than 5, or less than 3. The film, coating, or layer, despite being, in some embodiments, nonporous (infinite Gurley), substantially non-porous (Gurley greater than 7,000 s/100 cc), or semi-porous (Gurley (s/100 cc) of 6,000 to 7,000), is ionically conductive at least due to the presence of the ionically conductive additive. In some embodiments, particularly where a ceramic is used, the film, coating, or layer may be porous (Gurley (s/100 cc) less than 6,000, less than 5,000, less than 4,000, less than 3,000, less than 2,000, less than 1,000, or less than 500).

### Porous or Microporous Polymeric Base Film

The porous or microporous polymeric base film may be any commercially available separator microporous membranes (e.g. single ply or multi-ply), for example, the Celgard® dry process products produced by Celgard, LLC of Charlotte, N.C., or the Hipore® wet process products produced by Asahi Kasei Corporation of Tokyo, Japan. The base film may have a porosity in the range of 20-80%, preferably in the range of 30-60%, an average pore size in the range of 0.02 to 2 microns, preferably in the range of 0.05 to 0.5 micron, a Gurley Number in the range of 5 to 150 sec, preferably 15 to 60 sec. (Gurley Number refers to the time it takes for 10 cc of air at 12.2 inches of water to pass through one square inch of membrane), and is preferably polyolefinic. Preferred polyolefins include polyethylene and/or polypropylene. Polypropylene may be most preferred (high temp polymer, oxidation resistant).

A base film or coating substrate can in some instances comprise a semi-crystalline polymer, such as polymers having a crystallinity in the range of 20 to 80%.

In some embodiments, the porous or microporous polymeric base film described herein can comprise a single layer, a bi-layer, a tri-layer, or multilayers. For example, a tri-layer or multilayer substrate can comprise two outer layers and one or more inner layers. In some instances, the porous or microporous polymeric base film can comprise 1, 2, 3, 4, 5, or more inner layers. As described in more detail below, each of the layers can be coextruded and/or laminated together.

The porous or microporous polymeric base film described herein can be made by a dry stretch process (such as a Celgard® dry stretch process described herein) in which one or more polymers are extruded to form the substrate. Each of the outer and inner layers can be monoextruded, where the layer is extruded by itself, without any sublayers (plies), or each layer can comprise a plurality of co-extruded sublayers. For example, each layer can comprise a plurality of sublayers, such as a co-extruded bi-sublayer, tri-sublayer, or multi-sublayer substrate, each of which can collectively considered to be a “layer”. The number of sublayers in coextruded bi-layer is two, the number of layers in a co-extruded tri-layer is three, and the number of layers in a co-extruded multi-layer substrate will be two or more, three or more, four or more, five or more, and so on. The exact number of sublayers in a co-extruded layer is dictated by the die design and not necessarily the materials that are co-extruded to form the co-extruded layer. For example, a co-extruded bi-, tri-, or multi-sublayer substrate can be formed using the same material in each of the two, three, or four or more sublayers, and these sublayers will still be considered to be separate sublayers even though each sublayer is made of the same material.

In some embodiments, a tri-layer or multilayer porous or microporous polymeric base film described herein can comprise two outer layers (such as a first outer layer and a second outer layer) and a single or plurality of inner layers. The plurality of inner layers can be monoextruded or co-extruded layers. A lamination barrier can be formed between each of the inner layers and/or between each of the outer layers and one of the inner layers. A lamination barrier can be formed when two surfaces, such as two surfaces of different substrates or layers are laminated together using heat, pressure, or heat and pressure.

In some embodiments, a porous or microporous polymeric base film described herein can have the following non-limiting constructions: PP, PE, PP/PP, PP/PE, PE/PP, PE/PE, PP/PP/PP, PP/PP/PE, PP/PE/PE. PP/PE/PP, PE/PP/PE, PE/PE/PP, PP/PP/PP/PP, PP/PE/PE/PP, PE/PP/PP/PE, PP/PE/PP/PP, PE/PE/PP/PP, PE/PP/PE/PP, PP/PE/PE/PE/PP, PE/PP/PP/PP/PE, PP/PP/PE/PP/PP, PE/PE/PP/PP/PE/PE, PP/PE/PP/PE/PP, PP/PP/PE/PE/PP/PP, PE/PE/PP/PP/PE/PE, PE/PP/PE/PP/PE/PP, PP/PE/PP/PE/PP/PE, PP/PP/PP/PE/PP/PP/PP, PE/PE/PE/PP/PE/PE/PE, PP/PE/PP/PE/PP/PE/PP, PE/PP/PE/PP/PE/PP/PE, PE/PP/PE/PP/PE/PP/PE/PP, PP/PE/PP/PE/PP/PE/PP/PE, PP/PP/PE/PE/PP/PP/PE/PE, PP/PE/PE/PE/PE/PE/PE/PP, PE/PP/PP/PP/PP/PP/PP/PE, PP/PP/PE/PE/PEPE/PP/PP, PP/PP/PP/PP/PE/PE/PE/PE, PP/PP/PP/PP/PE/PP/PP/PP/PP, PE/PE/PE/PE/PP/PE/PE/PE/PE, PP/PE/PP/PE/PP/PE/PP/PE/PP, PE/PP/PE/PP/PE/PP/PE/PP/PE, PE/PE/PE/PE/PE/PP/PP/PP/PP, PP/PP/PP/PP/PP/PE/PE/PE/PE, PP/PP/PP/PP/PP/PE/PE/PE/PE/PE, PE/PE/PE/PE/PE/PP/PP/PP/PP/PP, PP/PE/PP/PE/PP/PE/PP/PE/PP/PE, PE/PP/PE/PP/PE/PP/PE/PP/PE/PP, PE/PP/PP/PP/PP/PP/PP/PP/PP/PP/PE, PP/PE/PE/PE/PE/PE/PE/PE/PE/PE/PP, PP/PP/PE/PE/PP/PP/PE/PE/PP/PP, PE/PE/PP/PP/PP/PP/PP/PP/PP/PE/PE, PP/PP/PP/PE/PE/PP/PP/PP/PP/PE, or PE/PE/PE/PP/PP/PE/PE/PE/PP/PP. For purposes of reference herein PE denotes a single layer within the multilayer porous or microporous polymeric base film that comprises PE. Similarly, PP denotes a single layer within the multilayer porous or microporous polymeric base film that comprises PP. Thus, a PP/PE designation would represent a bi-layer porous or microporous polymeric base film having a polypropylene (PP) layer and a polyethylene (PE) layer. The bilayer could be coextruded or each layer of the bilayer could be separately monoextruded and laminated together.

Individual layers in the porous or microporous polymeric base film can comprise a plurality of sublayers, which can be formed by co-extrusion or combining the individual sublayers to form the individual layer of the multilayer substrate. Using a multilayer porous or microporous polymeric base film having a structure of PP/PE/PP, each individual PP or PE layer can comprise two or more co-extruded sublayers. For example, when each individual PP or PE layer comprises three sublayers, each individual PP layer can be expressed as PP=(PP1,PP2,PP3) and each individual PE layer can be expressed as PE=(PE1,PE2,PE3). Thus, the structure of PP/PE/PP can be expressed as (PP1,PP2,PP3)/(PE1,PE2,PE3)/(PP1,PP2,PP3). The composition of each of the PP1, PP2, and PP3 sublayers can be the same, or each sublayer can have a different polypropylene composition than one or both of the other polypropylene sublayers. Similarly, composition of each of the PE1, PE2, and PE3 sublayers can be the same, or each sublayer can have a different polyethylene composition than one or both of the other polyethylene sublayers. This principle applies to other multilayer porous or microporous polymeric base films having more or less layers than the above-described exemplary tri-layer film.

In some embodiments, a porous or microporous polymeric base film described herein has an overall thickness of 1 micron to 60 microns, 1 micron to 55 microns, 1 micron to 50 microns, 1 micron to 45 microns, 1 micron to 40 microns, 1 micron to 35 microns, 1 micron to 30 microns, 1 micron to 25 microns, 1 micron to 20 microns, 1 micron to 15 microns, 1 micron to 10 microns, 5 microns to 50 microns, 5 microns to 40 microns, 5 microns to 30 microns, 5 microns to 25 microns, 5 microns to 20 microns, 5 microns to 10 microns, 10 microns to 40 microns, 10 microns to 35 microns, 10 microns to 30 microns, or 10 microns to 20 microns.

In some embodiments, each layer in bi-layer, tri-layer, or multi-layer porous or microporous polymeric base film can have a thickness equal to a thickness of the other layers, or have a thickness that is less than or greater than a thickness of the other layers. For example, when a porous or microporous polymeric base film is a tri-layer film comprising a structure of PP/PE/PP (polypropylene/polyethylene/polypropylene) or PE/PP/PE (polyethylene/polypropylene/polyethylene), the polypropylene layers can have a thickness equal to a thickness of the polyethylene layer(s), have a thickness less than a thickness of the polyethylene layer(s), or have a thickness greater than a thickness of the polyethylene layer(s).

In some embodiments, a porous or microporous polymeric base film described herein can be a tri-layer laminated PP/PE/PP (polypropylene/polyethylene/polypropylene) or a PE/PP/PE (polyethylene/polypropylene/polyethylene) substrate. In some instances, a structure ratio of the layers of the porous or microporous polymeric base film can comprise 45/10/45%, 40/20/40%, 39/22/39%, 38/24/38%, 37/26/37%, 36/28/36%, 35/30/35%, 34.5/31/34.5%, 34/32/34%, 33.5/33/33.5%, 33/34/33%, 32.5/35/32.5%, 32/36/32%, 31.5/37/31.5%, 31/38/31%, 30.5/39/30.5%, 30/40/30%, 29.5/41/29.5%, 29/42/29%, 28.5/43/28.5%, 28/44/28%, 27.5/45/27.5%, or 27/46/27%.

A porous or microporous polymeric base film described herein can additionally comprise fillers, elastomers, wetting agents, lubricants, flame retardants, nucleating agents, antioxidants, colorants, and/or other additional elements not inconsistent with the objectives of this disclosure. For example, the substrate can comprise fillers such as calcium carbonate, zinc oxide, diatomaceous earth, talc, kaolin, synthetic silica, mica, clay, boron nitride, silicon dioxide, titanium dioxide, barium sulfate, aluminum hydroxide, magnesium hydroxide and the like, or combinations thereof. Elastomers can comprise ethylene-propylene (EPR), ethylene-propylene-diene (EPDM), styrene-butadiene (SBR), styrene isoprene (SIR), ethylidene norbornene (ENB), epoxy, and polyurethane or combinations thereof. Wetting agents can comprise ethoxylated alcohols, primary polymeric carboxylic acids, glycols (such as polypropylene glycol and polyethylene glycols), functionalized polyolefins, and the like. Lubricants can comprise a silicone, a fluoropolymer, oleamide, stearamide, erucamide, calcium stearate, lithium stearate, or other metallic stearates. Flame retardants can comprise brominated flame retardants, ammonium phosphate, ammonium hydroxide, alumina trihydrate, and phosphate ester. Nucleating agents can comprise any nucleating agents not inconsistent with the objectives of this disclosure, such as beta-nucleating agents for polypropylene, which is disclosed in U.S. Pat. No. 6,602,593.

A porous or microporous polymeric base film described in some of the embodiments herein, can in some instances, be made by a dry-stretch process. A substrate is understood to be a thin, pliable, polymeric membrane, film, sheet, foil, or substrate having a plurality of pores extending therethrough. In some cases, the porous substrate is made by the dry-stretch process (also known as the CELGARD® dry stretch process), which refers to a process where pore formation results from stretching a nonporous, semi-crystalline, extruded polymer precursor in the machine direction (MD), transverse direction (TD), or in both an MD and TD. See, for example, Kesting, Robert E., Synthetic Polymeric Membranes, A Structural Perspective, Second Edition, John Wiley & Sons, New York, N.Y., (1985), pages 290-297, incorporated herein by reference. Such a dry-stretch process is different from the wet process and the particle stretch process. Generally, in the wet process, also known as a phase inversion process, an extraction process, or a TIPS process, a polymeric raw material is mixed with a processing oil (sometimes referred to as a plasticizer), this mixture is extruded, and pores are formed when the processing oil is removed. While these wet process substrates may be stretched before or after the removal of the oil, the principle pore formation mechanism is the use of the processing oil. See, for example, Kesting, Ibid. pages 237-286, incorporated herein by reference. A particle stretch process uses particles, such as silica or calcium carbonate, as the pore former. The polymeric raw material is mixed with the particles, this mixture is extruded, and pores are formed when the particles are removed. While these particle filled substrates may be stretched before or after the removal of the particles, the principle pore formation mechanism is the use of the particles. A porous substrate described herein can in some instances preferably be any Celgard® polyolefin microporous separator substrate available from Celgard, LLC of Charlotte, N.C.

A porous polymeric base film can be a macroporous, mesoporous, microporous, or nanoporous. The porosity of the substrate can be any porosity not inconsistent with the goals of this disclosure. For example, any porosity that could form an acceptable battery separator is acceptable. In some embodiments, the porosity of the porous substrate is from 20 to 90%, from 20 to 80%, from 40 to 80%, from 20 to 70%, from 40 to 70%, from 40-60%, more than 20%, more than 30%, or more than 40%. Porosity is measured using ASTM D-2873 and is defined as the percentage of void space, e.g., pores, in an area of the porous substrate, measured in the Machine Direction (MD) and the Transverse Direction (TD) of the substrate. In some embodiments, the pores are slit like, are round with a sphericity factor of 0.25 to 8.0, are oblong, are trapezoidal, or are oval-shaped.

A porous or microporous polymeric base film can have any Gurley not inconsistent with the objectives of this disclosure, such as a Gurley that is acceptable for use as a battery separator. Gurley is the Japanese Industrial Standard (JIS Gurley) and can be measured using a permeability tester, such as an OHKEN permeability tester. JIS Gurley is defined as the time in seconds required for 100 cc of air to pass through one square inch of substrate at a constant pressure of 4.9 inches of water. In some embodiments, the porous film or substrate described herein has a JIS Gurley (s/100 cc) of 100 or more, 150 or more, 160 or more, 170 or more, 180 or more, 190 or more, 200 or more, 210 or more, 220 or more, 230 or more, 240 or more, 250 or more, 260 or more, 270 or more, 280 or more, 290 or more, 300 or more, 310 or more, 320 or more, 330 or more, 340 or more, 350 or more, 100 to 800, 200 to 700, 200 to 600, 200 to 500, 200 to 400, 200 to 300, or 300 to 600.

A porous or microporous polymeric base film can have a puncture strength, uncoated, of 200 gf or more, 210 gf or more, 220 gf or more, 230 gf or more, 240 gf or more, 250 gf or more, 260 gf or more, 270 gf or more, 280 gf or more, 290 gf or more, 300 gf or more, 310 gf or more, 320 gf or more, 330 gf or more, 340 gf or more, 350 gf or more, or as high as 400 gf or more.

In some embodiments, a porous or microporous polymeric base film described herein can comprise one or more additives in at least one layer of the porous substrate. In some embodiments, at least one layer of a porous or microporous polymeric base film comprises more than one, such as two, three, four, five, or more, additives. Additives can be present in one or both of the outermost layers of the porous substrate, in one or more inner layers, in all of the inner layers, or in all of the inner and both of the outermost layers. In some embodiments, additives can be present in one or more outermost layers and in one or more innermost layers. In such embodiments, over time, an additive can be released from the outermost layer or layers and the additive supply of the outermost layer or layers can be replenished by migration of the additive in the inner layers to the outermost layers. In some embodiments, each layer of a porous or microporous polymeric base film can comprise a different additive or combination of additives than an adjacent layer of the porous or microporous polymeric base film.

In some embodiments, an additive comprises a functionalized polymer. As understood by one of ordinary skill in the art, a functionalized polymer is a polymer with functional groups coming off of the polymeric backbone. In some embodiments, the functionalized polymer is a maleic anhydride functionalized polymer. In some embodiments the maleic anhydride modified polymer is a maleic anhydride homo-polymer polypropylene, copolymer polypropylene, high density polypropylene, low-density polypropylene, ultra-high density polypropylene, ultra-low density polypropylene, homo-polymer polyethylene, copolymer polyethylene, high density polyethylene, low-density polyethylene, ultra-high density polyethylene, ultra-low density polyethylene,

In some embodiments, an additive comprises an ionomer. An ionomer, as understood by one of ordinary skill in the art is a copolymer containing both ion-containing and non-ionic repeating groups. Sometimes the ion-containing repeating groups can make up less than 25%, less than 20%, or less than 15% of the ionomer. In some embodiments, the ionomer can be a Li-based, Na-based, or Zn-based ionomer.

In some embodiments, an additive comprises cellulose nanofiber.

In some embodiments, an additive comprises inorganic particles having a narrow size distribution. For example, the difference between D10 and D90 in a distribution is less than 100 nanometers, less than 90 nanometers, less than 80 nanometers, less than 70 nanometers, less than 60 nanometers, less than 50 nanometers, less than 40 nanometers, less than 30 nanometers, less than 20 nanometers, or less than 10 nanometers. In some embodiments, the inorganic particles are selected from at least one of SiO₂, TiO₂, or combinations thereof.

In some embodiments, an additive comprises a lubricating agent. A lubricating agent or lubricant described herein can be any lubricating agent not inconsistent with the objectives of this disclosure. As understood by one of ordinary skill in the art, a lubricant is a compound that acts to reduce the frictional force between a variety of different surfaces, including the following: polymer:polymer; polymer:metal; polymer; organic material; and polymer:inorganic material. Specific examples of lubricating agents or lubricants as described herein are compounds comprising siloxy functional groups, including siloxanes and polysiloxanes, and fatty acid salts, including metal stearates.

Compounds comprising two or more, three or more, four or more, five or more, six or more, seven or more, eight or more, nine or more, or ten or more siloxy groups can be used as the lubricant described herein. Siloxanes, as understood by those in the art, are a class of molecules with a backbone of alternating silicon atom (Si) and oxygen (O) atoms, each silicon atom can have a connecting hydrogen (H) or a saturated or unsaturated organic group, such as —CH3 or C2H5. Polysiloxanes are a polymerized siloxanes, usually having a higher molecular weight. In some embodiments described herein, the polysiloxanes can be high molecular weight, such as ultra-high molecular weight polysiloxanes. In some embodiments, high and ultra-high molecular weight polysiloxanes can have weight average molecular weights ranging from 500,000 to 1,000,000.

A fatty acid salt described herein can be any fatty acid salt not inconsistent with the objectives of this disclosure. In some instances, a fatty acid salt can be any fatty acid salt that acts as a lubricant. The fatty acid of the fatty acid salt can be a fatty acid having between 12 to 22 carbon atoms. For example, the metal fatty acid can be selected from the group consisting of: Lauric acid, myristic acid, palmitic acid, stearic acid, oleic acid, linoleic acid, linolenic acid, palmitoleic acid, behenic acid, erucic acid, and arachidic acid. The metal can be any metal not inconsistent with the objectives of this disclosure. In some instances, the metal is an alkaline or alkaline earth metal, such as Li, Be, Na, Mg, K, Ca, Rb, Sr, Cs, Ba, Fr, and Ra. In some embodiments, the metal is Li, Be, Na, Mg, K, or Ca.

A fatty acid salt can be lithium stearate, sodium stearate, lithium oleate, sodium oleate, sodium palmitate, lithium palmitate, potassium stearate, or potassium oleate.

A lubricant, including the fatty acid salts described herein, can have a melting point of 200° C. or above, 210° C. or above, 220° C. or above, 230° C. or above, or 240° C. or above. A fatty acid salt such as lithium stearate (melting point of 220° C.) or sodium stearate (melting point 245 to 255° C.) has such a melting point.

In some embodiments, an additive can comprise one or more nucleating agents. As understood by one of ordinary skill in the art, nucleating agents are, in some embodiments, materials, inorganic materials, that assist in, increase, or enhance crystallization of polymers, including semi-crystalline polymers.

In some cases, an additive can comprise a cavitation promoter. Cavitation promoters, as understood by those skilled in the art, are materials that form, assist in formation of, increase formation of, or enhance the formation of bubbles or voids in the polymer.

An additive can comprise a fluoropolymer in some instances, such as the fluoropolymers discussed in detail herein.

In some embodiments, an additive can comprise a cross-linker.

An additive described herein can in some embodiments comprise an x-ray detectable material. An x-ray detectable material can be any x-ray detectable material not inconsistent with the objectives of this disclosure, such as, for example, those disclosed in U.S. Pat. No. 7,662,510, which is incorporated by reference herein in its entirety. Suitable amounts of the x-ray detectable material or element are also disclosed in the '510 patent, but in some embodiments, up to 50 weight %, up to 40 weight %, up to 30 weight %, up to 20 weight %, up to 10 weight %, up to 5 weight %, or up to 1 weight % based on the total weight of the porous or microporous polymeric base film can be used. In an embodiment, the additive is barium sulfate.

In some embodiments, an additive can comprise a lithium halide. The lithium halide can be lithium chloride, lithium fluoride, lithium bromide, or lithium iodide. The lithium halide can be lithium iodide, which is both ionically conductive and electrically insulative. In some instances, a material that is both ionically conductive and electrically insulative can be used as part of the porous or microporous polymeric base film.

In some embodiments, an additive can comprise a polymer processing agent. As understood by those skilled in the art, polymer processing agents or additives are added to improve processing efficiency and quality of polymeric compounds. In some embodiments, the polymer processing agent can be antioxidants, stabilizers, lubricants, processing aids, nucleating agents, colorants, antistatic agents, plasticizers, or fillers.

In some embodiments, an additive can comprise high temperature melt integrity (HTMI) polymer. The HTMI polymer can be any HTMI polymer not inconsistent with the objectives of this disclosure. In some instances, the HTMI polymer can be at least one selected from the group consisting of PMP, PMMA, PET, PVDF, Aramid, syndiotactic polystyrene, polyimide, polyamide, and combinations thereof. In some embodiments, the HTMI polymer may be at least one selected from the group consisting of polyamide imide and polyetherimide.

An additive can optionally comprise an electrolyte. Electrolytes as described herein can be any electrolyte not inconsistent with the objectives of this disclosure. The electrolyte can be any additive typically added by battery makers, particularly lithium battery makers to improve battery performance. Electrolytes should also be capable of being combined, such as miscible, with the polymers used for the porous or microporous polymeric base film or compatible with the coating slurry. Miscibility of the additives can also be assisted or improved by coating or partially coating the additives. For example, exemplary electrolytes are disclosed in A Review of Electrolyte Additives for Lithium-Ion Batteries, J. of Power Sources, vol. 162, issue 2, 2006 pp. 1379-1394, which is incorporated by reference herein in its entirety. In some embodiments, the electrolyte is at least one selected from the group consisting of a solid electrolyte interphase (SEI) improving agent, a cathode protection agent, a flame retardant additive, LiPF₆ salt stabilizer, an overcharge protector, an aluminum corrosion inhibitor, a lithium deposition agent or improver, or a solvation enhancer, an aluminum corrosion inhibitor, a wetting agent, and a viscosity improver. In some embodiments, the electrolyte can have more than one property, such as it can be a wetting agent and a viscosity improver.

Exemplary SEI improving agents include VEC (vinyl ethylene carbonate), VC (vinylene carbonate), FEC (fluoroethylene carbonate), LiBOB (Lithium bis(oxalato) borate). Exemplary cathode protection agents include N,N′-dicyclohexylcarbodiimide, N,N-diethylamino trimethylsilane, LiBOB. Exemplary flame-retardant additives include TTFP (tris(2,2,2-trifluoroethyl) phosphate), fluorinated propylene carbonates, MFE (methyl nonafluorobuyl ether). Exemplary LiPF₆ salt stabilizers include LiF,TTFP (tris(2,2,2-trifluoroethyl) phosphite), 1-methyl-2-pyrrolidinone, fluorinated carbamate, hexamethyl-phosphoramide. Exemplary overcharge protectors include xylene, cyclohexylbenzene, biphenyl, 2,2-diphenylpropane, phenyl-tert-butyl carbonate. Exemplary Li deposition improvers include AlI₃, SnI₂, cetyltrimethylammonium chlorides, perfluoropolyethers, tetraalkylammonium chlorides with a long alkyl chain. Exemplary ionic salvation enhancer include 12-crown-4, TPFPB (tris(pentafluorophenyl)). Exemplary Al corrosion inhibitors include LiBOB, LiODFB, such as borate salts. Exemplary wetting agents and viscosity diluters include cyclohexane and P₂O₅.

In some embodiments, the electrolyte additive is air stable or resistant to oxidation. A battery separator comprising the electrolyte additive disclosed herein can have a shelf life of weeks to months, e.g. one week to 11 months.

In some embodiments, an additive can comprise an energy dissipative non-miscible additive. Non-miscible means that the additive is not miscible with the polymer used to form the layer of the porous or microporous polymeric base film that contains the additive.

A porous or microporous polymeric base film described herein can be MD stretched or TD stretched to make the film porous. In some instances, the porous or microporous polymeric base film is produced by sequentially performing a TD stretch of an MD stretched substrate, or by sequentially performing an MD stretch of a TD stretched substrate. In addition to a sequential MD-TD stretching (with or without relax), the substrate can also simultaneously undergo a biaxial MD-TD stretching (with or without relax). Moreover, the simultaneous or sequential MD-TD stretched porous substrate can be followed by a subsequent stretching, reaxing, heat setting, or calendering step to reduce the substrate's thickness, reduce roughness, reduce percent porosity, increase TD tensile strength, increase uniformity, and/or reduce TD splittiness.

In some embodiments, a porous or microporous polymeric base film can comprise pores having an average pore size of 0.01 nm to 1 micron, 0.01 micron to 1 micron, 0.02 micron to 1 micron, 0.03 micron to 1 micron, 0.04 micron to 1 micron, 0.05 micron to 1 micron, 0.06 micron to 1 micron, 0.07 micron to 1 micron, 0.08 micron to 1 micron, 0.09 micron to 1 micron, 0.1 micron to 1 micron, 0.2 micron to 1 micron, 0.3 micron to 1 micron, 0.4 micron to 1 micron, 0.5 micron to 1 micron, 0.6 micron to 1 micron, 0.7 micron to 1 micron, 0.8 micron to 1 micron, 0.9 micron to 1 micron, 0.01 micron to 0.9 micron, 0.01 micron to 0.8 micron, 0.01 micron to 0.7 micron, 0.01 micron to 0.6 micron, 0.01 micron to 0.5 micron, 0.01 micron to 0.4 micron, 0.01 micron to 0.3 micron, 0.01 micron to 0.2 micron, 0.01 micron to 0.1 micron, 0.01 micron to 0.09 micron, 0.01 micron to 0.08 micron, 0.01 micron to 0.07 micron, 0.01 micron to 0.06 micron, 0.01 micron to 0.05 micron, 0.01 micron to 0.04 micron, 0.01 micron to 0.03 micron, 1 micron, 0.9 micron, 0.8 micron, 0.7 micron, 0.6 micron, 0.5 micron, 0.4 micron, 0.3 micron, 0.2 micron, 0.1 micron, 0.09 micron, 0.08 micron, 0.07 micron, 0.06 micron, 0.05 micron, 0.04 micron, 0.03 micron, 0.02 micron, or 0.01 micron.

In an embodiment, a porous or microporous polymeric base film can be manufactured using an exemplary process that includes stretching and a subsequent calendering step such as a machine direction stretching followed by transverse direction stretching (with or without machine direction relax) and a subsequent calendering step as a method of reducing the thickness of such a stretched substrate, for example, a multilayer porous substrate, in a controlled manner, to reduce the percent porosity of such a stretched substrate, for example, a multilayer porous or microporous polymeric base film, in a controlled manner, and/or to improve the strength, properties, and/or performance of such a stretched substrate, for example, a multilayer porous substrate, in a controlled manner, such as the puncture strength, machine direction and/or transverse direction tensile strength, uniformity, wettability, coatability, runnability, compression, spring back, tortuosity, permeability, thickness, pin removal force, mechanical strength, surface roughness, hot tip hole propagation, and/or combinations thereof, of such a stretched substrate, for example, a multilayer porous substrate, in a controlled manner, and/or to produce a unique structure, pore structure, material, substrate, base substrate, and/or separator.

In some instances, the TD tensile strength of the multilayer porous or microporous polymeric base film can be further improved by the addition of a calendering step following TD stretching. The calendering process typically involves heat and pressure that can reduce the thickness of a porous substrate. The calendering process step can recover the loss of MD and TD tensile strength caused by TD stretching. Furthermore, the increase observed in MD and TD tensile strength with calendering can create a more balanced ratio of MD and TD tensile strength which can be beneficial to the overall mechanical performance of the multilayer porous or microporous polymeric base film.

The calendering process can use uniform or non-uniform heat, pressure and/or speed to selectively densify a heat sensitive material, to provide a uniform or non-uniform calender condition (such as by use of a smooth roll, rough roll, patterned roll, micro pattern roll, nano pattern roll, speed change, temperature change, pressure change, humidity change, double roll step, multiple roll step, or combinations thereof), to produce improved, desired or unique structures, characteristics, and/or performance, to produce or control the resultant structures, characteristics, and/or performance, and/or the like. In an embodiment, a calendering temperature of 50° C. to 70° C. and a line speed of 40 to 80 ft/min can be used, with a calendering pressure of 50 to 200 psi. The higher pressure can in some instances provide a thinner separator, and the lower pressure provide a thicker separator.

In some embodiments, a porous or microporous polymeric base film described herein can comprise a coating positioned on the first surface, on the second surface, or on both the first and second surfaces of the porous substrate. This is shown schematically in FIG. 1

In accordance with at least selected embodiments, the instant disclosure or invention is preferably directed to a polyamide-imide coated membrane, separator membrane, or separator for a lithium battery such as a high energy or high voltage rechargeable lithium battery and the corresponding battery. In certain particular embodiments, the battery may be a Li Metal Battery, a Sodium Battery, or a Sulfur Battery. The separator preferably includes a porous or microporous polyamide-imide coating or layer on at least one side of a polymeric microporous layer, membrane or film. The polyamide-imide coating or layer may include other polymers, additives, fillers, or the like. The polyamide-imide coating may be adapted, for example, to provide oxidation resistance, to block dendrite growth, to add dimensional and/or mechanical stability, to reduce shrinkage, to add high temperature performance (HTMI function), to prevent electronic shorting at temperatures above 200 deg C., and/or the like. The microporous polymeric base layer may be adapted, at least, to hold liquid, gel, or polymer electrolyte, to conduct ions, and/or to block ionic flow between the anode and the cathode in the event of thermal runaway (shutdown function). The polyamide-imide coated separator may be adapted, for example, to keep the electrodes apart at high temperatures, to provide oxidation resistance, to block dendrite growth, to add dimensional stability, to reduce shrinkage, to add high temperature performance (HTMI function), to prevent electronic shorting at temperatures above 200 deg C., to increase puncture strength, and/or to block ionic flow between the anode and the cathode in the event of thermal runaway (shutdown function). Although secondary lithium battery usage may be preferred, the instant polyamide-imide coated membrane may be used in a battery, cell, primary battery, capacitor, fuel cell, textile, filter, and/or composite, and/or as a layer or component in other applications, devices, and/or the like.

In accordance with at least certain embodiments, the separator has at least one polyamide-imide coating or layer that contains at least polyamide-imide and one or more pore formers (such as plasticizer, solvent, poor solvent, particles, or polymers), and may be made semi-porous or porous by removing at least some of the pore former from a coating formulation of at least polyamide-imide and pore former, polyamide-imide, another polymer and pore former, or polyamide-imide, polymers and pore former.

In accordance with at least selected embodiments, the separator has at least one polyamide-imide coating or layer that contains at least polyamide-imide and one or more other polymers or co-polymers, and may be non-porous (yet still ionically conductive in electrolyte, especially if thin or including PVDF, PVDF:HFP, and/or other polymers or materials that wet, fill, swell, or gel in electrolyte), semi-porous, microporous, nanoporous, or porous. It may be preferred that the polyamide-imide coating or layer be continuous, but other discontinuous or broken patterns, dots, islands, stripes, or the like may be used. For example, closely spaced dots may be digitally printed on the base film or substrate. Also, the coating and the base film may be coextruded, cascade cast, stretched together, extracted together, and/or the like.

In accordance with at least certain selected embodiments, the polyamide-imide coated separator for a high energy or high voltage rechargeable lithium battery, comprises:

a solid state electrolyte (SSE) layer or substrate, and

a polyamide-imide coating or layer on at least one side of the SSE layer.

In accordance with at least certain other embodiments, the separator has at least one polyetherimide coating or layer instead of a polyamide-imide layer.

In accordance with at least selected embodiments, aspects or objects, there are provided novel or improved coated membranes, coated materials, coatings, separators, coated separators, polyamide-imide coated membranes, separator membranes, or separators for lithium batteries such as a high energy or high voltage rechargeable lithium batteries, and the corresponding batteries including same as shown, described, or claimed herein. The batteries may be Lithium Batteries, Lithium Ion Batteries, Lithium Polymer Batteries, Lithium Secondary Batteries, Lithium Ion Rechargeable Batteries, Li Metal (anode) Batteries, Li Sulfur (Li—S) Batteries, Li SSE Batteries, Li Metal SSE Batteries, Sodium SSE Batteries, Sulfur SSE Batteries, Sodium Sulfur (NaS) Batteries, Li Iron Disulfide (Li/FeS₂) Batteries, Graphite (cathode) Batteries, Li Metal (anode) Graphite (cathode) Batteries, Sodium Batteries, NMC or NCM Batteries, Capacitors, and/or the like. In at least certain embodiments, the polyamide-imide coated membranes are adapted to be wet with liquid electrolyte, to be filled with gel electrolyte, and/or the like. In at least other certain embodiments, at least the polyamide-imide coating or coatings is or are adapted to be wet with liquid electrolyte, to be filled with gel electrolyte, and/or the like.

In accordance with at least certain embodiments, aspects or objects, the problems, issues, or shortcoings of certain prior separators are addressed by the present novel or improved coated membranes, coated materials, coatings, separators, coated separators, polyamide-imide coated membranes, separator membranes, or separators for lithium batteries such as a high energy or high voltage rechargeable lithium batteries, and the corresponding batteries including same as shown, described, or claimed herein.

In some embodiments, the coating can comprise a first layer and a second layer. In some instances, the first layer of the coating can be positioned on the first surface of the substrate, on the second surface of the substrate, or on both the first and second surfaces of the substrate. When the first layer is positioned on the first and/or second surfaces of the substrate, the second layer of the coating can be positioned over one or both of the first layer(s) of the coating.

In some embodiments, the second layer of the coating can be positioned on the first surface of the substrate, on the second surface of the substrate, or on both the first and second surfaces of the substrate. When the second layer is positioned on the first and/or second surfaces of the substrate, the first layer of the coating can be positioned over one or both of the second layer of the coating.

In further embodiments, the first layer of the coating can be positioned on one of the first surface or second surface of the substrate, and the second layer of the coating can be positioned on the other of the first surface or second surface of the substrate. In this embodiment, the first layer on one of the surfaces of the substrate can optionally be covered with the second layer, and the second layer on the other of the surfaces of the substrate can optionally covered with the first coating, such that the first and second surfaces a have an opposite configuration of coating layers.

Further still, in other embodiments, the first layer can be positioned on both the first and second surfaces of the substrate, and only one of the two first layers on the substrate is additionally covered with a second layer of the coating. Similarly, in other instances, the second layer can be positioned on both the first and second surfaces of the substrate, and only one of the two second layers on the substrate is additionally covered with the first layer of the coating.

The first layer and the second layer can each have any thickness not inconsistent with the objectives of this disclosure. In some cases, the first layer has a thickness of 10 nm to 20 microns, 500 nm to 15 microns, 500 nm to 10 microns, 500 nm to 5 microns, or 500 nm to 1 micron The second layer can have a thickness of 500 nm to 20 microns, 500 nm to 15 microns, 500 nm to 10 microns, 500 nm to 5 microns, or 500 nm to 1 micron. The thickness of the first and second layers may be the same or different.

In another aspect, a method of preparing a coated separator described above comprises coating a first surface, an opposite facing second surface, or both the first surface and the second surface of a porous substrate with a layer, first layer and/or a second layer

The present invention may be embodied in other specific forms without departing from the spirit or essential attributes thereof and, accordingly, reference should be made to the claims, drawings or specification, as indicating the scope of the invention.

### EXAMPLES

### Examples 1 and 2

As a first step, a coating solution was prepared by combining a PVDF-HFP with less than 20% HFP and a polyamide-imide (Solvay Torlon) in NMP. The solution was amber but clear, which is surprising because typically polyimides and PVDFs are not miscible as demonstrated in the Comparative Example 2.

Next, the coating solution was coated onto one side of a porous polymeric base film. In this example, Celgard® 2500 PP base film was used. After coating, there are two ways to remove NMP. One is oven drying and other is NMP extraction with water bath followed by air drying. The later method is preferred as it is faster, effective and better membrane formation. FIG. 2 shows the entire lab coating process using water extraction process.

Two separate samples were produced using different NMP removing methods. The resulted Thickness of the separator (base film+coating) and Gurley (seconds) were measured, and appearance visually and at 15× magnification was determined. The results are presented in FIG. 3. As shown in FIG. 3, the water-immersion method produced a smoother coating than the oven-drying method. Both films had infinite Gurley.

### Examples 3-5

Coating solutions were prepared like in Examples 1 and 2. In Examples 3 and 4 the ratio of PAI/PVDF is as shown in the Table in FIG. 4 below. In Examples 3-5, the coating was coated onto Celgard® 2500 as the base film. In each of Examples 3-5, the solvent (NMP) was removed using a water chasing method with overnight air dry. The immersion time was varied between 2 and 5 minutes. As shown in the Table in FIG. 4, the longer immersion time of 5 minutes produced a lower Gurley coating. It is believed that the ER of Example 4 will also be lower than that in Example 3, but it has not yet been measured. The Table in FIG. 4 also shows that a higher ratio of PAI/PVDF resulted in a lower ER film (compare Examples 3 and 5 with the same water immersion times) Comparative Example 1 shows the shrinkage and ER of an uncoated 2500 base film. ER of the coated films were measured by soaking coated films in the electrolyte for 1 hr to swell PVDF. SEMs of base film and coated base-film are provided in FIGS. 5A and 5B.

FIG. 6 shows that Example 5 wets with electrolyte solvent, propylene carbonate (PC). This is shown by the area becoming transparent.

### Example 6 and 7 and Comparative Example 2

Examples 6-8 and Comparative Example 2 were prepared like Examples 1 and 2, except that in Comparative Example 2 polyimide (PI) was used instead of polyamide-imide (PAI). Removal or substantial removal of solvent was achieved as shown in the Table in FIG. 7 below. The SEMs of these Examples show that the water immersion process produces the smoothest coating, which is more preferable for a battery separator. Compare Example 6 and 7. It also shows that films formed with PI instead of PAI do not work. PI is not miscible with PVDF at all. This is shown by even the naked eye appearance of the coating. Compare Comparative Example 2 and Example 6. See FIG. 7.

### Non-Limiting Example Lithium Battery Description:

Cylindrical lithium iron disulfide batteries use lithium for the anode, iron disulfide for the cathode, and a lithium salt in an organic solvent blend as the electrolyte. A cutaway (FIG. 8) of a typical cylindrical LiFeS2 battery is illustrated in the following diagram:

1. A polyamide-imide coated separator for a high energy or high voltage rechargeable lithium battery, comprising:
a microporous polymeric layer, membrane or film, and
a polyamide-imide coating or layer on at least one side of the microporous polymeric layer, wherein
said polyamide-imide coating or layer may be adapted to provide oxidation resistance, to block dendrite growth, to add dimensional stability, to reduce shrinkage, to add high temperature performance (HTMI function), to prevent electronic shorting at temperatures above 200 deg C., and/or the like, and
wherein said microporous polymeric layer may be adapted to hold liquid electrolyte, to conduct ions, and/or to block ionic flow between the anode and the cathode of a cell or battery in the event of thermal runaway (i.e., a shutdown function).

2. (canceled)

3. (canceled)

4. The separator according to claim 1, wherein said polyamide-imide coating or layer is nonporous, semi-porous, porous, microporous, mesoporous, macroporous, and/or nanoporous.

5. The separator according to claim 4 wherein said polyamide-imide coating or layer may be made porous by removing plasticizer, pore former, and/or particles from a coating formulation of at least polyamide-imide and at least one of a plasticizer, pore former, particles, or combinations thereof.

6. The separator according to claim 5 wherein said polyamide-imide coating or layer contains at least polyamide-imide and particles or polymers, and may be made semi-porous or porous by removing at least some of the particles from a coating formulation of at least polyamide-imide and particles, polyamide-imide, another polymer and particles, or polyamide-imide, polymers and particles.

7. The separator according to claim 5 wherein:
said particles or polymers are selected from PVDF, PVDF-HFP, others that are ionically conductive, or mixtures thereof;
inorganic or ceramic particles are also part of the coating formulation and may or may not be removed;
said particles, including said inorganic or ceramic particles, may be removed with one or more solvents;
said particles, including said inorganic or ceramic particles, may be removed with one or more solvents, wherein said one or more solvents are water, water-based solvents, HF, or mixtures thereof; or
said particles are solvent dissolvable particles or polymers, or are not solvent dissolvable particles or polymers.

8. (canceled)

9. (canceled)

10. (canceled)

11. (canceled)

12. The separator according to claim 5 wherein:
said polyamide-imide coating or layer may be made semi-porous or porous by removing plasticizer from a coating formulation of at least polyamide-imide and plasticizer; or
said polyimide coating or layer may be made semi-porous or porous by removing pore former from a coating formulation of at least polyamide-imide and pore former.

13. (canceled)

14. The separator according to claim 1 wherein:
said polyamide-imide coating or layer may include other polymers, additives, fillers, and/or the like;
said polyamide-imide of said polyamide-imide coating or layer is selected from the group consisting of a neat polyamide-imide, a 30% glass fiber polyamide-imide, a 30% carbon fiber polyamide-amide, a polyamide-imide comprising carbon fiber, a polyamide-imide comprising graphite, and combinations thereof;
said polyamide-imide of said polyamide-imide coating or layer is a neat polyamide-imide; or
said polyamide-imide coating or layer is selected from the group consisting of a 30% glass fiber polyamide-imide, a 30% carbon fiber polyamide-amide, a polyamide-imide comprising carbon fiber, a polyamide-imide comprising graphite, and combinations thereof.

15. (canceled)

16. (canceled)

17. (canceled)

18. The separator according to claim 5 wherein before being removed said particles comprise between 20% to 80% by weight of said polyamide-imide and particles mixture.

19. The separator according to claim 1 wherein:
said microporous polymeric layer is a polyolefinic membrane;
said microporous polymeric layer is a polyolefinic membrane that is a polypropylene and/or polyethylene containing membrane; or
said microporous polymeric layer is a polyolefinic membrane that has a porosity in the range of 20-80%, an average pore size in the range of 0.02 to 1.0 microns, and a Gurley Number in the range of 5 to 500 sec.

20. (canceled)

21. (canceled)

22. The separator according to claim 5 wherein said particles have an average particle size in the range of 0.001 to 10 microns.

23. A high energy or high voltage rechargeable lithium battery comprising: an anode, a cathode, a separator according to any of claim 1 disposed between said anode and said cathode, and an electrolyte in ionic communication with said anode and said cathode via said separator.

24. A high energy rechargeable lithium battery comprising: an anode containing lithium metal or lithium-alloy or a mixtures of lithium metal and/or lithium alloy and another material; a cathode; a separator according to any of claim 1 disposed between said anode and said cathode; and an electrolyte in ionic communication with said anode and said cathode via said separator.

25. A polyamide-imide coated membrane adapted for a high energy or high voltage rechargeable lithium battery, a battery, a cell, a primary battery, a secondary battery, a capacitor, a fuel cell, a textile, a filter, and/or a composite, and/or as a layer or component in other applications, devices, and/or the like, comprising:
a microporous base layer, membrane or film, and
a polyamide-imide coating or layer on at least one side of the microporous base layer, membrane or film, wherein the microporous base layer, membrane or film is a polymeric layer, more preferably a polyolefinic layer, and most preferably a dry stretch process polyolefinic layer.

26. A polyamide-imide coated separator for a high energy or high voltage rechargeable lithium battery, comprising:
a microporous polymeric layer, membrane or film, and
a polyamide-imide coating or layer on at least one side of the microporous polymeric layer, wherein the separator has a Gurley of infinity or less, an electrical resistance (ohm-cm²) of 30 or less or both.

27. The separator of claim 26, wherein:
the separator has a Gurley (s/100 cc) of infinity or less, preferably 7,000 or less, more preferably 6,000 or less, 5,000 or less, 4,000 or less, 3,0000 or less, 2,000 or less, 1,000 or less, or 500 or less;
the separator has an electrical resistance (ohm-cm²) of 30 or less, more preferably 25 or less, 20 or less, 15 or less, 10 or less, 5 or less, or 3 or less; or
the separator has both a Gurley (s/100 cc) of infinity or less, preferably 7,000 or less, more preferably 6,000 or less, 5,000 or less, 4,000 or less, 3,0000 or less, 2,000 or less, 1,000 or less, or 500 or less, and an electrical resistance of 30 or less, more preferably 25 or less, 20 or less, 15 or less, 10 or less, 5 or less, or 3 or less.

28. (canceled)

29. (canceled)

30. The separator of claim 26, wherein:
the polyamide-imide coating layer comprises polyamide-imide and an ionically conductive additive;
the polyamide-imide coating layer comprises polyamide-imide and an ionically conductive additive, wherein the ionically conductive additive is an ionically conductive polymer;
the polyamide-imide coating layer comprises polyamide-imide and an ionically conductive additive, wherein the ionically conductive additive is an ionically conductive polymer that is at least one selected from the group consisting of a PVDF, PVDF-HFP, and combinations thereof; or
the polyamide-imide coating layer comprises polyamide-imide and an ionically conductive additive, wherein the ionically conductive additive is an ionically conductive polymer that is PVDF-HFP where the percentage of HFP is between 5 and 35%, less than 30%, less than 25%, less than 20%, less than 15%, or less than 10%.

31. (canceled)

32. (canceled)

33. (canceled)

34. The separator of any one of claim 25, wherein the polyamide-imide coating or layer is formed by a method comprising:
forming a film or layer or coating by applying a coating solution comprising a polyamide-imide, an ionically conductive polymer, and a solvent on at least one side of the microporous polymeric layer, membrane or film or by applying a coating slurry comprising a polyamide-imide, an ionically conductive polymer, a ceramic, and a solvent on at least one side of the microporous polymeric layer, membrane or film;
removing or substantially removing the solvent from the film, coating, or layer using oven heating or by immersing the film, coating, or layer in or spraying the film, layer, or coating with an aqueous solution or pure water to extract the solvent and then drying the film or layer.

35. The separator of claim 34, wherein:
the aqueous solution comprises more than 50% water, and preferably 100% water;
the solvent is removed or substantially removed from the film or layer by immersing the film, coating, or layer in or spraying the film, layer, or coating with an aqueous solution or 100% water to extract the solvent and then drying the film or layer;
the solvent is removed or substantially removed from the film or layer by immersing the film, coating, or layer in or spraying the film, layer, or coating with an aqueous solution or 100% water to extract the solvent and then drying the film or layer, wherein the aqueous solution comprises more than 50% water, preferably 100% water;
the film or layer is immersed in or in contact with the aqueous solution or 100% water for 1 second to 30 minutes; or
the film or layer is immersed in or in contact with the aqueous solution or 100% water for 1 second to 30 minutes, wherein the aqueous solution comprises more than 50% water, preferably 100% water.

36. (canceled)

37. (canceled)

38. (canceled)

39. The separator of claim 34, wherein:
the ionically conductive polymer is at least one selected from the group consisting of PVDF, PVDF-HFP, or combinations thereof;
the solvent is NMP or another solvent that can dissolve polyamide-imide and/or be extracted using water or an aqueous solution; or
the ceramic is at least one selected from the group consisting of SiO₂, alumina, alkaline metal salts (KCl, LiCl, etc.), and combinations thereof and the ceramic can be removed or cannot be removed from the film, layer, or coating.

40. (canceled)

41. (canceled)

42. A polyamide-imide separator for a high energy or high voltage rechargeable lithium battery, comprising:
a free-standing polyamide-imide layer or film that comprises, consists of, or consists essentially of a polyamide-imide and at least one ionically conductive additive.

43. The separator of claim 42, wherein the polyamide-imide is selected from the group consisting of a neat polyamide-imide, a 30% glass fiber polyamide-imide, a 30% carbon fiber polyamide-amide, a polyamide-imide comprising carbon fiber, a polyamide-imide comprising graphite, and combinations thereof.

44. The separator of claim 42, wherein:
the ionically conductive additive is an ionically conductive polymer;
the ionically conductive additive is an ionically conductive polymer that is at least one selected from the group consisting of a PVDF, PVDF-HFP, and combinations thereof;
the ionically conductive additive is an ionically conductive polymer that is PVDF-HFP and the HFP content is between 5 and 35%;
the separator has a Gurley (s/100 cc) of infinity or less, an electrical resistance of 30 or less, or both;
the separator has a Gurley (s/100 cc) of infinity or less, preferably 7,000 or less, 6,000 or less, 5,000 or less, 4,000 or less, 3,000 or less, 2,000 or less, or 1,000 or less;
the separator has an electrical resistance of 30 or less, preferably 25 or less, 20 or less, 15 or less, 10 or less, 5 or less, or 3 or less; or
the separator has both a Gurley (s/100 cc) of infinity or less, preferably 7,000 or less, 6,000 or less, 5,000 or less, 4,000 or less, 3,000 or less, 2,000 or less, or 1,000 or less and an electrical resistance of 30 or less, preferably 25 or less, 20 or less, 15 or less, 10 or less, 5 or less, or 3 or less.

45. (canceled)

46. (canceled)

47. (canceled)

48. (canceled)

49. (canceled)

50. (canceled)

51. The separator of claim 42, wherein the HTMI-polymer layer is formed by a method comprising:
forming a layer or film by applying a coating solution comprising a polyamide-imide, an ionically conductive polymer, and a solvent on a support such as a glass substrate or by applying a coating slurry comprising an a polyamide-imide, an ionically conductive polymer, a solvent, and a ceramic on a support such as a glass substrate;
removing or substantially removing the solvent from the layer using oven heating or by immersing the film or layer in or spraying the film or layer with an aqueous solution to extract the solvent and then drying the film or layer.

52. The separator of claim 51, wherein:
the aqueous solution comprises more than 50% water, and preferably 100% water; or
the polyamide-imide is selected from the group consisting of a neat polyamide-imide, a 30% glass fiber polyamide-imide, a 30% carbon fiber polyamide-amide, a polyamide-imide comprising carbon fiber, a polyamide-imide comprising graphite, and combinations thereof.

53. (canceled)

54. The separator of claim 51, wherein:
the ionically conductive additive is an ionically conductive polymer;
the ionically conductive additive is an ionically conductive polymer that is at least one selected from the group consisting of PVDF, a PVDF-HFP, and combinations thereof; or
the ionically conductive additive is an ionically conductive polymer that is a PVDF-HFP wherein the HFP content is between 5 and 35%.

55. (canceled)

56. (canceled)

57. The separator of claim 51, wherein:
the solvent is removed or substantially removed by immersing the layer in or spraying the layer with an aqueous solution to extract the solvent and then drying the layer;
the layer is immersed in the aqueous solution for 1 second to 30 minutes;
the ceramic is at least one selected from the group consisting of SiO₂, alumina, alkaline metal salts (KCl, LiCl, etc.), and combinations thereof and the ceramic may be removed or may not be removed to form the final film or layer; or
the solvent is NMP or another solvent that can dissolve polyamide-imide and/or be extracted by water or an aqueous solution.

58. (canceled)

59. (canceled)

60. (canceled)

61. The separator according to claim 1 wherein:
said polyamide-imide coating or layer contains at least polyamide-imide and one or more pore formers (such as plasticizer, solvent, poor solvent, particles, or polymers), and may be made semi-porous or porous by removing at least some of the pore former from a coating formulation of at least polyamide-imide and pore former, polyamide-imide, another polymer and pore former, or polyamide-imide, polymers and pore former; or
said polyamide-imide coating or layer contains at least polyamide-imide and one or more other polymers or co-polymers, and may be non-porous (yet still ionically conductive in electrolyte), semi-porous, microporous, nanoporous, or porous.

62. (canceled)

63. A polyamide-imide coated separator for a high energy or high voltage rechargeable lithium battery, comprising:
a solid state electrolyte (SSE) layer or substrate, and
a polyamide-imide coating or layer on at least one side of the SSE layer.

64. A polyamide-imide separator for a high energy or high voltage rechargeable lithium battery, comprising:
At least one layer of at least polyamide-imide, polyamide-imide and pore former, polyamide-imide, another polymer and pore former, and/or polyamide-imide, other polymers and pore former.

65. The separator of claim 1, wherein polyetherimide is used instead of polyamide-imide.

66. (canceled)
